(19) United States
(12) Patent Application Publication
(10) Pub. No.: US 2011/0017681 A1
(43) Pub. Date: Jan. 27, 2011

(54) FILTRATION APPARATUS FOR FILTERING A FLUID AND METHODS OF USING THE SAME

(76) Inventors: Joshua A. Bibey, Taylorsville, NC (US); David C. Woodcock, Taylorsville, NC (US); Brian E. Woodcock, Hildebran, NC (US); Michael L. Reid, Conover, NC (US)

Correspondence Address: JENKINS, WILSON, TAYLOR & HUNT, P. A., 3100 Tower Blvd., Suite 1200, DURHAM, NC, 27707, US

(21) Appl. No.: 12/788,060

(22) Filed: May 26, 2010

Related U.S. Application Data
(60) Provisional application No. 61/181,173, filed on May 26, 2009.

(51) Int. Cl. B01D 35/16

(52) U.S. Cl. 210/791; 210/333.01; 210/138

(57) ABSTRACT

Filtration apparatuses for use in polymer processing systems and methods of using the same are provided. The filtration apparatuses can include a housing with one or more supply channels and discharge channels. The filtration apparatus can also include one or more screen-bearing pistons with filter screen cavities therein for receiving filter screens that filter material flowing from the supply channels through the filter screens and out through the discharge channels. Back flushing channels can be formed by alignment of mating channels in the pistons and the housing. The filtration apparatuses can also include a controller that can communicate with a hydraulic power unit to that can be assisted by a rapid accelerator device to control the filtration apparatus. The filtration apparatuses can include filter screen retention plates.

### RELATED APPLICATIONS

The presently disclosed subject matter claims the benefit of U.S. Provisional Patent Application Ser. No. 61/181,173, filed May 26, 2009; the disclosure of which is incorporated herein by reference in its entirety.

### TECHNICAL FIELD

The present subject matter relates to filtration apparatuses for filtering fluid-like materials. For example, the present subject matter relates to filtration apparatuses for molten materials for polymer processing and extrusion related applications.

### BACKGROUND

Back Flush Screen Changers are used for applications such as filtering recycled (post-consumer and/or post-industrial) and highly contaminated polymers or other molten type materials in the extrusion process. A typical application would include a contaminated polymer being extruded into a molten resin type material, filtered or cleansed with filter media (hereafter referred to as “screen packs”) utilized in a back flush screen changer, then re-pelletized or cast into a tube, sheet, or other profile.

Due to the contamination in the polymer being filtered, the screen packs often become less effective as the filtered contamination blocks and clogs the screen packs. Back flush type screen changers typically rely on reversing the melt flow of the material being processed. This reversal of the melt flow flushes the contaminated screen packs with pressurized melt and purges the contaminants from the housing of the filtration device into atmosphere. In order to reverse the melt flow of material, screen-bearing pistons must be moved to a certain flow geometry (hereafter referred to as a “back flush position”), designed into the filtration device and its housing. Once in the back flush position, a small amount of pressurized melt purges embedded contamination from the screen pack to a purge port or “back flush port” in the housing, where the soiled material exits the housing and can be collected and/or disposed of.

Back Flushing type filtration devices in the past have offered various characteristics, primarily concentrating on the flow geometry internal to the housing. Some of these filtration devices have specific flow geometries that permit the back flushing material to exit the inlet face of the housing. Such designs allow the molten material to exit the housing by migrating to other piping/equipment in line. This action creates cleaning issues and the possibility of pre-maturely damaging heating elements utilized with other piping/equipment. Thus, while the screen pack is purged of contaminates and the back flushing of the screen packs causes other problems that, if left unattended, can lead to safety, cleanliness, contamination, and equipment malfunction concerns.

Thus, despite past efforts, an ongoing need exists to provide a back flush screen changer filtration device, which addresses the above concerns. Such a back flush screen changer filtration apparatus can provide back flush purging ports that can increase the effectiveness of the back flushing cycle and reduce the amounts of material necessary for the effective back flush. Such a back flush screen changer filtration apparatus can have better screen retention, and/or reduce disruptions while screen-bearing pistons are actuated inside of the housing.

### SUMMARY

In accordance with this disclosure, filtration apparatuses for filtering fluids are provided that permit back flushing of screen packs. It is an object of the presently disclosed subject matter to provide a filtration apparatus that has purging capabilities. For example, a filtration apparatus can be provided that has increased purging capacity and utilizes less material. The filtration apparatus can provide a location for purging that prevents or reduces the opportunity for serious injury to the operator and reduce the need for cleaning of the filtration apparatus. The filtration apparatus can provide multiple common purge ports in a housing where multiple filter screen cavities can be purged non-concurrently.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a perspective view of an embodiment of filtration apparatus according to the present subject matter;

FIG. 2 illustrates a front or inlet view of the filtration apparatus according to FIG. 1 showing portions of an internal geometry of the filtration apparatus;

FIG. 3 illustrates a top view of the filtration apparatus according to FIG. 1 showing portions of an internal geometry of the filtration apparatus;

FIG. 4 illustrates an end view of the filtration apparatus according to FIG. 1 showing portions of an internal geometry of the filtration apparatus;

FIG. 5 illustrates a front or inlet view of the filtration apparatus according to FIG. 1 showing portions of an internal geometry of the filtration apparatus when a portion of a piston of the filtration apparatus is in a back flush position;

FIG. 6 illustrates a cross-sectional view of a portion of an embodiment of a filtration apparatus with a screen-bearing piston in a position where channels in the piston mate with bores in a housing according to the present subject matter;

FIG. 7 illustrates a front or inlet view of the filtration apparatus according to FIGS. 1 and 5 while apparatus is in back flush position;

FIG. 8 illustrates a partially cross-sectional perspective view of an end of the filtration apparatus, taken along section lines A-A in FIGS. 5 and 7;

FIG. 9 illustrates a cross-sectional end view of the filtration apparatus, taken along section lines A-A in FIGS. 5 and 7;

FIG. 10 illustrates a front view of an embodiment of a filter screen retention plate for an embodiment of a filtration apparatus according to the present subject matter;

FIG. 11 illustrates a cross sectional view of the filter screen retention plate, taken along section lines B-B in FIG. 10;

FIG. 12 illustrates a perspective view of the filter screen retention plate according to FIG. 10;

FIG. 13 illustrates a perspective view of the filter screen retention plate and corresponding location of the filter screen retention plate inside of the screen-bearing piston as it enters a housing of the filtration apparatus according to FIG. 1;

FIG. 14 illustrates a front or inlet view of the filtration apparatus according to FIG. 1 showing a portion of a flow geometry inside of the housing with screen-bearing pistons in normal operating positions;

FIG. 15 illustrates a front or inlet view of the filtration apparatus according to FIG. 1 showing a portion of a flow geometry inside of the housing with a screen-bearing piston in a screen change position for a filter screen cavity;

FIG. 16 illustrates a front or inlet view of the filtration apparatus according to FIG. 15 showing a portion of a flow geometry inside of the housing with a screen-bearing piston in a screen change position for a different filter screen cavity;

FIG. 17 illustrates a front or inlet view of the filtration apparatus according to FIG. 15 showing a portion of a flow geometry inside of the housing with a screen-bearing piston in a screen change position for a different filter screen cavity; and

FIG. 18 illustrates a front or inlet view of the filtration apparatus according to FIG. 15 showing a portion of a flow geometry inside of the housing with a screen-bearing piston in a screen change position for a different filter screen cavity.

### DETAILED DESCRIPTION

Reference will now be made in detail to the description of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the present subject matter cover such modifications and variations.

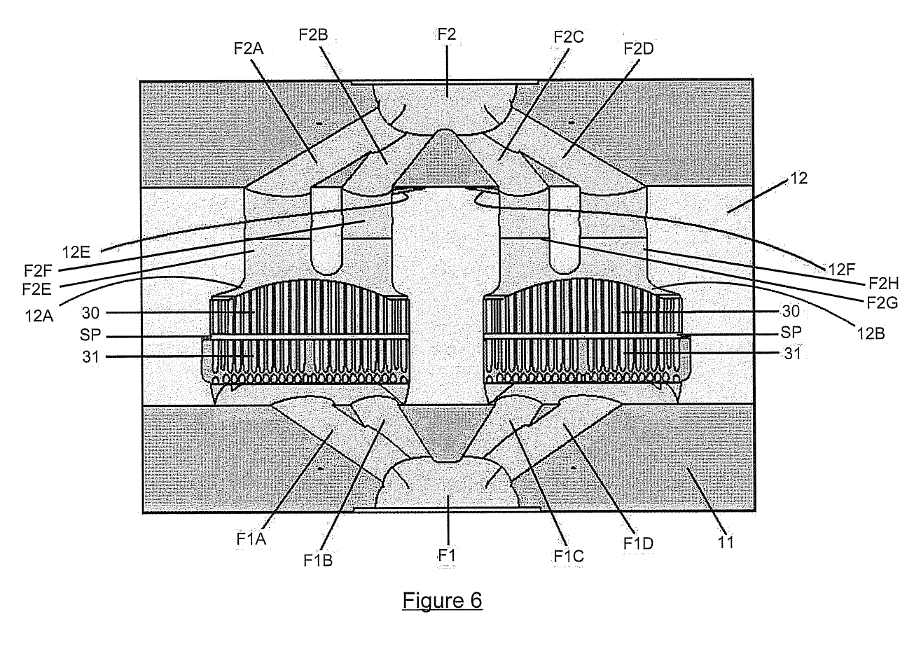

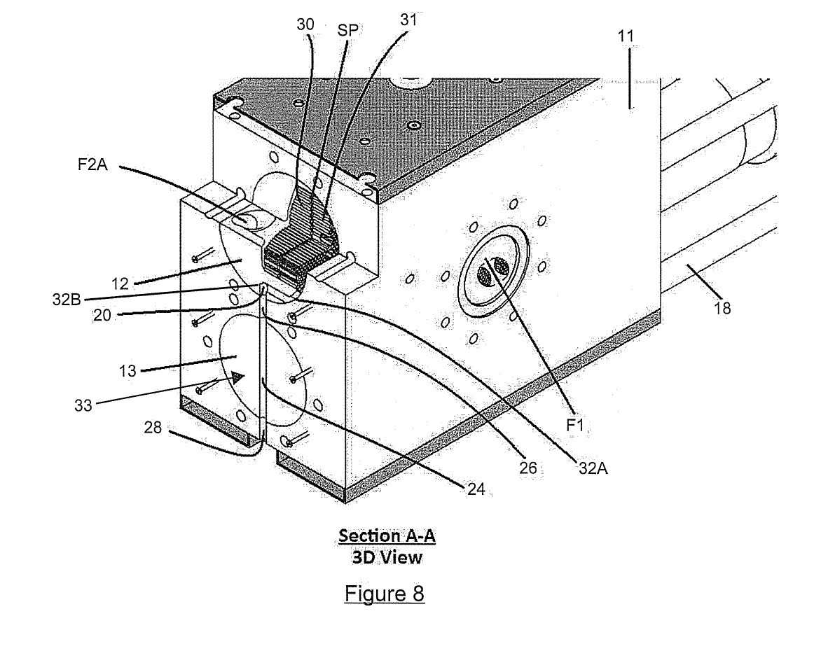

As shown in FIGS. 1-3 and 5-6, a filtration apparatus, generally designated 10, is provided for use in polymer processing systems. The filtration apparatus 10 can comprise a housing 11 that can include a main supply channel F1 and a main discharge channel F2, both of which are shown in dotted lines. A portion of the main supply channel F1 can be divided into one or more supply sub-channels F1A, F1B, F1C, F1D shown in dotted lines for directing a flow of material such a polymer to be filtered, to two or more filter screens, or screen packs, SP (see FIGS. 6 and 8). As shown in FIG. 3, portion of the main discharge channel 2 in the housing 11 can be divided into one or more discharge sub-channels F2A, F2B, F2C, F2D for receiving a flow of material, such as polymer from the two or more filter screens SP (see FIGS. 6 and 8). As shown in FIGS. 6 and 8, in some embodiments, the one or more discharge sub-channels F2A, F2B, F2C, F2D may be angled as compared to the direction orientation of the main supply channel F1 and the main discharge channel F2 and the direction of flow created by the main supply channel F1 and the main discharge channel F2.

The filtration apparatus 10 can also comprise one or more screen-bearing pistons. For example, as shown in the figures, two screen-bearing pistons 12 and 13 can be provided in the filtration apparatus 10. Each screen-bearing piston 12, 13 can comprise two or more filter screen cavities. For example, screen-bearing pistons 12, 13 can comprise filter screen cavities 12A, 12B, 13A, and 13B. Each filter screen cavity 12A, 12B, 13A, and 13B can be configured to receive a filter screen, or screen pack, SP as well as a breaker plate 30 and a screen retention plate 31.

Each screen-bearing piston 12, 13 can also comprise one or more piston supply channels that are alignable with the one or more supply sub-channels of the housing 11. In the embodiment shown, for example, screen-bearing piston 12 can comprise a large piston supply channel, or supply area, F1E, F1F in each filter screen cavity 12A, 12B in the screen-bearing piston 12. In such an embodiment, the large piston supply channel F1E can be aligned with supply sub-channels FM and F1B of the housing 11 when the screen-bearing piston is in its normal operational position as shown in FIGS. 3 and 6 to supply a flow of material, such as polymer, from the supply sub-channels F1A and F1B to the large supply channel F1E. Similarly, the large piston supply channel F1F can be aligned with supply sub-channels F1C and F1D of the housing 11 when the screen-bearing piston is in its normal operational position as shown in FIGS. 3 and 6 to supply a flow of material, such as polymer, from the supply sub-channels F2C and F2D to the large piston supply channel F1F. The size of the large piston supply channels F1E, F1F are such that alignment with the supply sub-channels F1A, F1B, F1C, F1D is more flexible. This flexibility allows the associated screen-bearing piston 12 and its filter screen cavities 12A, 12B to be moved to different positions and the respective supply sub-channels F1A, FIB, F1C, F1D can still supply a flow of polymer to the respective piston supply channel F1E, F1F.

Additionally, each screen-bearing piston 12, 13 can comprise one or more piston discharge channels that are alignable with the one or more discharge sub-channels of the housing 11. For example, screen-bearing piston can comprise piston discharge channels F2E, F2F, F2G, F2H that are alignable with the discharge sub-channels F2A, F2B, F2C, F2D of the housing 11 when the screen-bearing piston 12 is in its normal operational position as shown in FIGS. 3 and 6. Thus, when the piston 12 is in the normal operational position, discharge sub-channel F2A can align with piston discharge channel F2E. Similarly, discharge sub-channel F2B can align with piston discharge channel F2F, discharge sub-channel F2C can align with piston discharge channel F2G, and discharge sub-channel F2D can align with piston discharge channel F2H. Still, the piston discharge channels F2E, F2F, F2G, F2H can be aligned with the discharge sub-channels F2A, F2B, F2C, F2D of the housing 11 so that when either of the filter screen cavities 12A, 12B is in a back flushing position, the other filter screen cavity 12A, 12B, in the screen-bearing piston 12 continues to permit polymer flow. In this manner in the embodiment shown, when back flushing is occurring in one of the filter screen cavity 12A, 12B, 13A, and 13B, polymer can continue to flow through the other three of the four filter screen cavities 12A, 12B, 13A, and 13B.

Thus, filtration apparatus can comprise a housing and two sliding pistons which are the screen-bearing pistons for supporting filter screens, or screen packs. In the embodiment provided, each of these two screen-bearing pistons can have two or more filter screen cavities, for a total of four or more filter screen cavities. The housing can have one or more common upstream main supply channels for directing polymer flow that splits into eight or more smaller sub-channels. The screen-bearing pistons can be movable through the housing where the filter screen cavities can intersect with the sub-channels. Four of the smaller sub-channels in the upstream portion of the housing can mate with two filter screen cavities in one screen-bearing piston, while the other four smaller sub-channels in the upstream portion of the housing can mate with two filter screen cavities in the second screen-bearing piston.

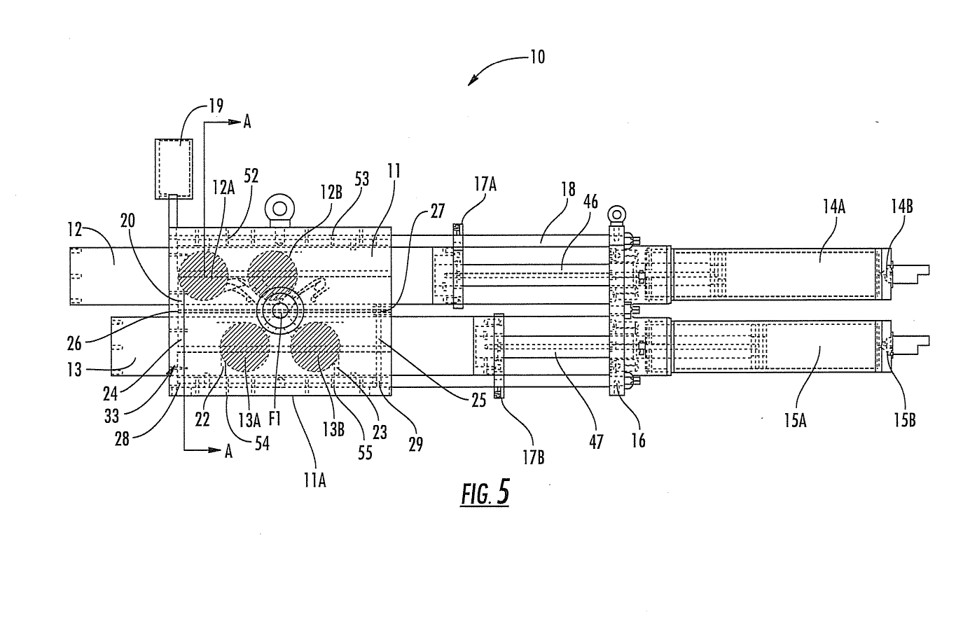

As filter screens, or filtration media screen packs, become contaminated or soiled, the filtration apparatus 10, which can be controlled and/or actuated via a controller C that can be interfaced with a hydraulic power unit HPU, as explained below, can be automatically actuated and positioned to a back flushing position (see FIGS. 5, 7, 8 and 9) for a back flushing cycle. While the filtration apparatus 10 is in each of its back flush positions, a portion of the polymer flow through the housing 11 can be restricted and/or re-directed to flow in a reverse direction across each of the four filter screens. There can be four back flushing positions that allow each of the four or more filter screen cavities to be purged independently. The purged and contaminated material can exit below the housing to atmosphere where it can be collected and disposed of.

Thus, as shown in FIGS. 2, 5, 7, 8, and 9, the filtration apparatus 10 can comprise a back flush channel that can be formed for each filter screen cavity 12A, 12B, 13A, 13B in the respective piston 12, 13. Each back flush channel can comprise one or more mating channels in the housing, such as mating channels 26, 27, 28, 29. Also, each back flush channel can comprise one or more mating channels in the one or more screen-bearing pistons when the screen-bearing piston for the respective back flush channel is in a back flushing position for the respective filter screen cavity. For example, mating channels 20, 21, 22, 23, 24, and 25 can be provided in the pistons 12, 13. As shown in FIGS. 5, 8, and 9, a back flush channel 33 can be formed by aligning the piston mating channel 20 in the piston 12, the housing mating channel 26 between the pistons 12 and 13, the piston mating channel 24 in the piston 13, and the housing mating channel 28, also referred to as back flush discharge channel 28 since it is the channel that discharges the purged material and contaminates to atmosphere through discharge outlet 28A. By aligning these channels in the manner described, back flush channel 33 is formed with piston 12 is in the back flushing position for screen cavity 12A to permit the back flushing of the filter screen disposed in the filter screen cavity 12A and the discharging of the purged material and contaminates.

Similarly, a back flush channel can be formed when the screen-bearing piston 12 is in a back flushing position for filter screen cavity 12B. For example, a back flush channel can be formed for filter screen cavity 12B by aligning piston mating channel 21 in the piston 12, the housing mating channel 27 between the pistons 12 and 13, the piston mating channel 25 in the piston 13, and the housing mating channel 29, also referred to as back flush discharge channel 29 since it is the channel that discharges the purged material and contaminates to atmosphere through discharge outlet 29A. For screen-bearing piston 13, two back flush channels can also be formed. For filter screen cavity 13A, a back flush channel can be formed when the screen-bearing piston 13 is in the correct back flushing position by aligning piston mating channel 22 in the piston 13 and the housing mating channel, or back flush discharge channel, 28.

The back flush discharge channels 28, 29 can be positioned at a bottom 11A of the housing 11. Each back flush channel can direct flow downward at a discharge outlet 28A, 29A of the respective back flush discharge channel 28, 29. Each back flush channel can direct flow of material being purged at the discharge outlet 28A, 29A of the respective back flush channel in a direction that is transverse to the direction of flow of material being filtered entering the main supply channel F1. For example, each back flush channel can also direct flow of material being purged at a discharge outlet 28A, 29A of the respective back flush channel in a direction that is about perpendicular to the direction of flow of material being filtered entering the main supply channel F1.

The discharge outlet 28A, 29A can permit material to be purged from the filtration apparatus 10 through the respective back flush channel to be recollected directly below the filtration apparatus 10. In such an embodiment, the discharge outlet 28A, 29A of the respective back flush channel that is formed can permit material purged from the filtration apparatus 10 through the respective back flush channel 28A, 29A to be recollected without further contact with the filtration apparatus 10 after discharge from the discharge outlet. Thus, the back flush channels can require minimal amounts of manual material removal from the apparatus. The back flush channels are formable in the middle of the housing for increased heat supplied to the back flush channels. In this manner, the back flush channel locations assist in the reduction and/or prevention of frozen polymer.

Each screen-bearing piston 12, 13 can further comprise a back flush supply channel for each filter screen cavity. For example, as shown in FIG. 6, the screen-bearing piston 12 can include a back flush supply channel 12E for the filter screen cavity 12A and a back flush supply channel 12F for the filter screen cavity 12B. The back flush supply channels 12E, 12F can be configured to allow for adjustable amounts of the flow of material for back flushing supplied to the respective filter screen cavity 12A, 12B. The back flush supply channels 12E, 12F in the screen-bearing piston 12 (or the screen-bearing piston 13) can allow for controllable amounts of downstream pressure variation during a back flushing cycle. The back flush supply channels 12E, 12F in the screen-bearing piston 12 (or screen-bearing piston 13) can also be utilized as ventilation channels to reduce polymer degradation areas in the apparatus.

When changing a filter screen SP from a respective filter screen cavity 12A, 12B within the screen-bearing piston 12 (or screen-bearing piston 13), the back flush channel for the respective filter screen cavity 12A, 12B can provide pressure relief for the filter screen cavities 12A, 12B before introducing the filter screen cavities 12A, 12B to the atmosphere during any screen change operation. In this manner, the mating channels 26, 27, 28, 29 in the housing 11 that support the screen-bearing pistons 12, 13 direct contaminants through the mating channels 20, 21, 22, 23, 24, and 25 in the screen-bearing pistons 12, 13 to the middle of the filtration apparatus 10 during a back flush cycle.

During the back flushing sequence, the filter screen being cleansed can be retained on its upstream side, preventing the filter screen from being dislodged from its proper location as will be explained below. To retain the screen in its proper location during back flushing, filter screen retention plates are utilized which must also allow an evenly distributed, reverse flow of material, ensuring the majority of contaminants across the entire screen pack filtration area are dislodged and purged to atmosphere.

During the back flushing sequence, the filtration apparatus 10, due to its internal flow geometry, allows polymer to continue to flow to any suitable downstream device, such as a machined die, from which polymeric sheets, tubes, and other profiles can be extruded. When screen packs become saturated with contaminants and the back flush sequence is not as effective in removing contaminants, then the soiled screen packs can be removed and replaced with new ones by moving the respective piston to a screen changing position for the respective filter screen and filter screen cavity. To achieve continuous production, the air from the filter screen cavity that was changed must be removed from the filtration apparatus 10. Venting stages that can be automatically actuated and positioned via a controller C interfaced with a hydraulic power unit HPU, can allow for any air inclusions to be removed from the filtration apparatus before moving the new filter screen, or screen pack, into production.

Thus, a filtration apparatus can be provided that has increased purging capacity and utilizes less material. The filtration apparatus can provide a location for purging that prevents or reduces the opportunity for serious injury to the operator. The filtration apparatus can provide two common purge ports in a housing where four filter screen cavities can be purged non-concurrently. Further, the filtration apparatus can provide a controller corresponding with a nitrogen charged accumulator assisted hydraulic system to minimize disruptions to the extrusion process.

As shown in FIGS. 1-3 and 5-6, the filtration apparatus 10 can comprise a housing 11 comprising one or more main supply channels F1 divided into multiple sub-channels F1A, F1B, F1C, F1D directing polymer flow through multiple filter screens. As above, the housing 11 can include multiple discharge sub-channels F2A, F2B, F2C, F2D combined into one or more main discharge channels F2. The housing 11 can also include multiple back flush discharge channels 28, 29. The plurality of screen-bearing pistons 12, 13, can be operated by a hydraulically operated power unit HPU to supply linear movement to the plurality of screen-bearing pistons 12, 13 and a controller C for controlling operation of the hydraulic power unit HPU and position control of the two screen-bearing pistons 12, 13. A rapid accelerator device ACC can be in communication with the hydraulically operated power unit HPU and the controller C to accelerate the linear movement of the screen-bearing pistons 12, 13 to reduce disruption of the flow of polymer being processed. The rapid accelerator device ACC can be, for example, an accumulator, a variable speed pump device, or some other speed increasing device. In the embodiment shown, rapid accelerator device ACC can be considered an accumulator.

For example, the rapid accelerator device ACC can be configured to automatically charge before movement of one of the screen-bearing pistons 12, 13 by the hydraulically operated power unit HPU to and from a screen changing position. Thereby, during movement of the screen-bearing piston 12, 13 to or from a screen changing position, a discharge of the rapid accelerator device ACC can permit an increase in a velocity of the respective screen-bearing piston 12, 13 over the back flush discharge channels 28, 29 in the housing 11. In this manner, the rapid accelerator device ACC can be used at specific times during the movement of the respective screen-bearing piston 12, 13 to prevent or reduce the loss or degradation of the polymer be processed.

In other instances, the increased velocity of the movement of the respective screen-bearing piston 12, 13 may not be as needed or desired. For example, when the respective screen-bearing piston 12, 13 is being moved to a back flush position like the position of the screen-bearing piston 12 as shown in FIGS. 5, 7, 8, and 9, the accuracy of the movement to a specific position, as discussed below, can be more important than the speed of travel to provide a more accurate alignment of the channels being used.

Similar, the accuracy of the movement of the respective screen-bearing piston 12, 13 to a venting position after a screen change to purge air from the system can also be more important than the speed of travel. Further, the accuracy of the movement of the respective screen-bearing piston 12, 13 to a normal operational position as shown in FIGS. 2 and 3 can also be more important than the speed of travel to provide a more accurate alignment of the channels for more efficient flow of the polymer through the filtration apparatus. Thus, if desired, the rapid accelerator device ACC can also be configured to not discharge during movement of one of the screen-bearing pistons 12, 13 by the hydraulically operated power unit HPU to at least one of a back flushing position, a normal operational position, or a venting position so that the velocity of the screen-bearing piston 12, 13 is not increased to more accurately hit the respective position to which the screen-bearing piston 12, 13 is being moved.

The hydraulically operated power unit HPU can be configured to position the screen-bearing pistons within about can also be configured to align the piston discharge channels F2E, F2F, F2G, F2H in the screen-bearing pistons 12, 13 with the discharge sub-channels F2A, F2B, F2C, F2D in the housing 11 within about 0.010 of an inch set point range to reduce polymer degradation areas. The controller C can be configured to operate the hydraulically operated power unit HPU to control the amount of time for each back flush cycle to increase application efficiency.

The hydraulically operated power unit HPU can be configured to interlock the screen-bearing pistons 12, 13 so that one screen-bearing piston will operate dependently of the other screen-bearing pistons while the other screen-bearing pistons remain in the normal operational position where the polymer flows through the filter screens SP. The controller C can be configured to operate the hydraulically operated power unit HPU to prevent the screen-bearing pistons 12, 13 from orienting themselves inappropriately to eliminate the possibility of terminating or disrupting the polymer flow.

Due to the stresses placed on the filter screens, or screen packs, SP (see FIG. 6), the filter screen SP may need to be changed due to fatigue, increased opportunity of failure, lack of efficiency in cleaning, and/or decreased throughput of the polymer flow. To provide for the opportunity of preventive maintenance, a screen change cycle can be automatically initiated based on certain criteria. For example, a screen change cycle may be initiated based on the frequency at which back flushing is needed. For example, if the flow of polymer through the filter screen SP is frequently slowed to a point that a back flush cycle is needed, the filter screen SP may need to be changed. Similarly, if the filter screen SP has experienced a high number of back flush cycles, the filter screen SP may be fatigued and need to be replaced.

Thus, the controller C of the filtration apparatus 10 can be configured so that if a back flush cycles are occurring at a specific timed set point, i.e. a specific time interval, a screen change cycle can be automatically initiated. Similarly, the controller C of the filtration apparatus 10 can be configured so that if a set number of back flush cycles have occurred on a given filter screen SP, a screen change cycle can also be automatically initiated. In such embodiments, the time interval between back flush cycles for a filter screen SP or the number of back flush cycles that a filter screen SP endures can be automatically set. Alternatively, a user or operator can set the time interval between back flush cycles for a filter screen SP or the number of back flush cycles that a filter screen SP endures. Therefore, the controller C can also be configured to operate the hydraulically operated power unit HPU to achieve an automatic initiation of any screen change cycle for any filter screen SP by at least one of a timed set point between back flush cycles or based on a number of back flush cycles that the filter screen SP endures.

Referring again to FIGS. 1, 2, and 3, the filtration apparatus 10 can be utilized in one or more types of polymer processing systems where a molten polymer or extrudate is required to be filtered. A typical application regarding polymer processing can include, but is not limited to, a pelletized or granulated polymer feedstock fed into an extruder (not shown). The extruder can be a motor-powered screw inside of a barrel housing, and provides a means for heating, melting, mixing, and conveying a molten or polymer type material. The polymer or extrudate can exit the end of the extruder and flow into the filtration apparatus 10. As the polymer or extrudate flows through the filtration apparatus 10, agglomerates or other contaminants can be filtered from the polymer flow or melt stream. As stated above, the filtration apparatus 10 can comprise two screen-bearing pistons. Each screen-bearing piston can include two screen packs, i.e., filter screens, where there are a total of four screen packs in the apparatus 10. The flow of the melt stream to each screen-bearing piston is depicted in FIG. 6 where the flowing material can enter the filtration apparatus at supply channel F1. The flowable material can then sub-divide into four smaller melt streams at flow bores F1A, F1B, F1C, and F1D. As shown in FIG. 6, once the extrudate passes through each of the four filter screen cavities (see FIG. 2 for filter screen cavities 2A, 2B, 3A, and 3B), the sub-divided melt flow can be united on the downstream side of the housing through flow channels F2A, F2B, F2C, and F2D, to a common discharge channel F2.

The filtration apparatus 10 will now be described in more detail. As shown in FIGS. 1-3 and as discussed above, the filtration apparatus 10 can comprise the housing 11, and two slideable screen-bearing pistons 12, 13. The filtration apparatus 10 generally comprises two individual hydraulic cylinders 14A and 15A. Each hydraulic cylinder 14A, 15A can be configured to actuate one slideable screen-bearing piston 12, 13, respectively. Each slideable screen-bearing piston 12, 13 can have internal linear positioning transducers generally designated 14B and 15B, which are wired into a remote controller C capable of automatically actuating the filtration apparatus. As shown in FIG. 5, one or more temperature sensing devices (not shown) such as thermocouples can be mounted to housing 11 to measure temperature at various locations designated 52, 53, 54, and 55.

Referring to FIGS. 1 and 2, the hydraulic cylinders 14A and 15A can be secured to housing 11 using an arrangement of a plurality of tie rods, generally designated 18. For example, six tie rods 18 can be used. The hydraulic cylinders 14A and 15A are secured to a mounting plate, generally designated 16 utilizing the tie rods 18. Each of the hydraulic cylinder's reciprocating pistons 46 and 47, shown in FIGS. 2, 5, and 7, which can be actuated with hydraulic pressure, can be secured to each of the screen-bearing pistons 12 and 13 with alignment plates 17A and 17B. Each alignment plate 17A and 17B can straddle one of the tie rods 18, allowing for proper alignment of flow bores F1A, F1B, F1C, F1D, F2A, F2B, F2C, and F2D shown in FIG. 6. FIG. 6 illustrates the flow geometry through one screen-bearing piston 12. For example, each screen-bearing piston 12 and 13 can have the same flow geometry as outlined in FIG. 6.

As shown in FIGS. 1 and 2, each hydraulic cylinder 14A and 15A can require hydraulic pressure to actuate each of their respective pistons 46, 47 in both reciprocating directions. Hydraulic hoses (not shown) can typically be used to connect the hydraulic cylinders 14A and 15A to a hydraulic power unit HPU. The hydraulic hoses can be connected to the cylinders 14A and 15A at hydraulic connections 48, 49, 50, and 51, illustrated in FIG. 1.

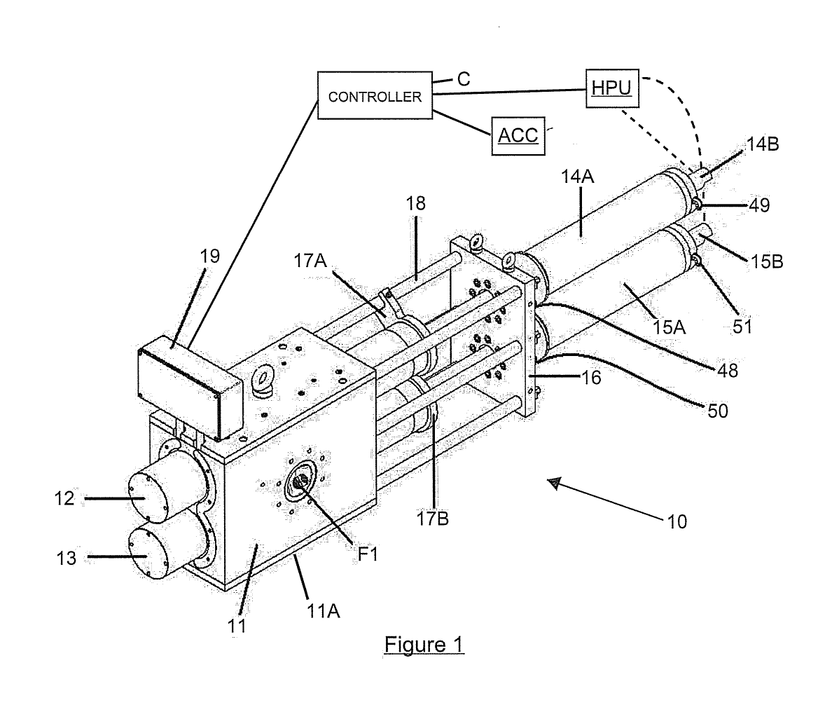

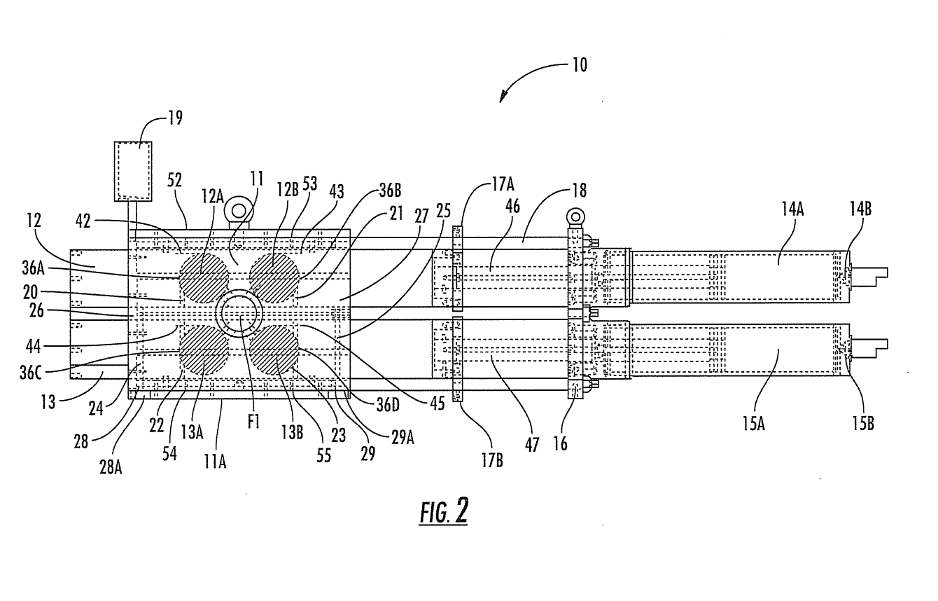

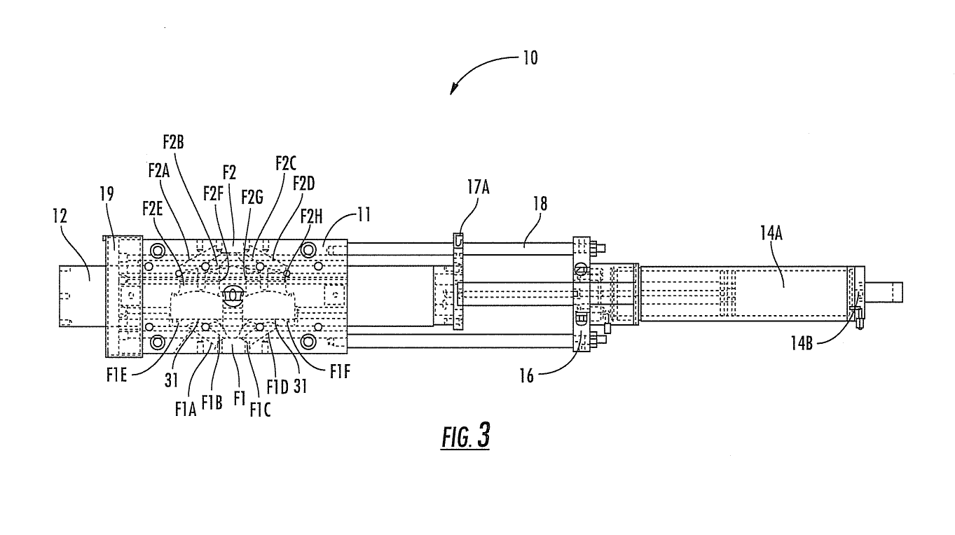

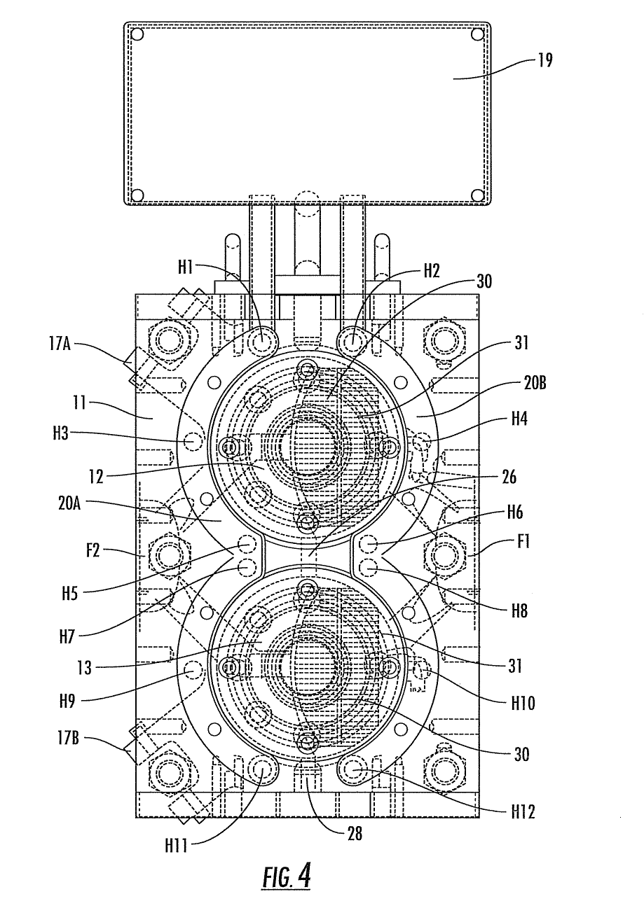

As shown in FIG. 4, one or more cartridge heater bores, such as cartridge heater bores H1, H2, H3, H4, H5, H6, H7, H8, H9, H10, H11, H12 can be utilized for centralized heating of the housing. Wire leads for cartridge heaters H1-H12 can travel through a milled channel in the side of the housing 11, and can be terminated and wired into junction box 19. The wire leads for cartridge heaters H1-H12 can be protected with wire way covers, generally designated 20A and 20B.

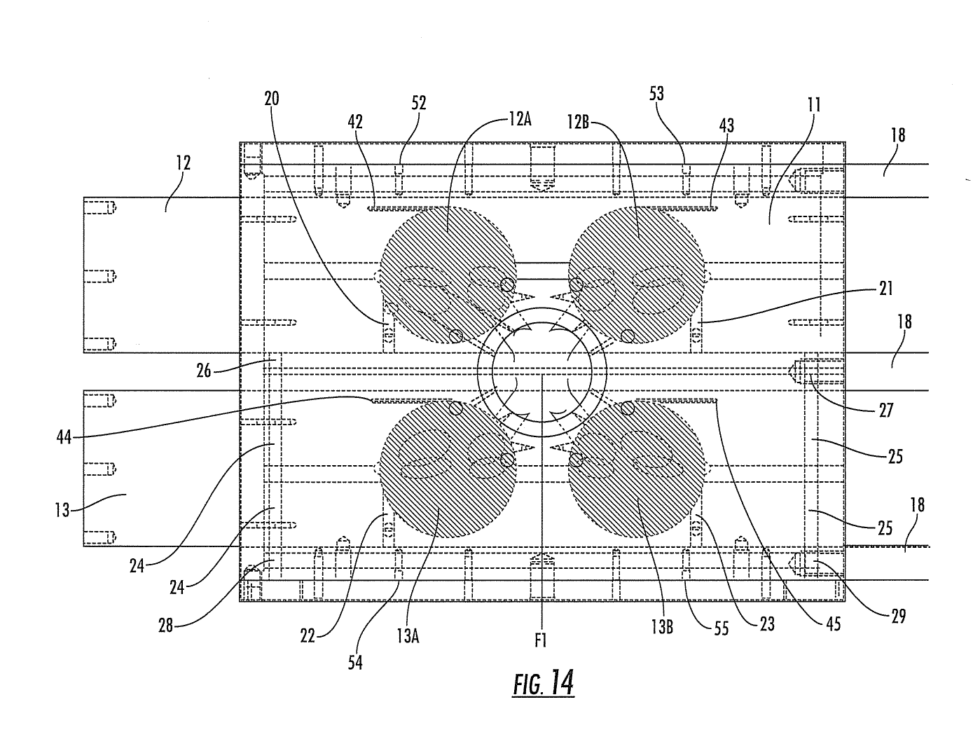

As shown in FIGS. 2 and 14, the screen-bearing pistons 12 and 13 can be in the normal flow or operating position, allowing polymer to flow through each filter screen cavity 12A, 12B, 13A, and 13B. As shown in FIG. 4, mounted inside of screen-bearing pistons 12 and 13 can be screen supports or breaker plates, generally designated 30. For example, there can be four total screen supports, or breaker plates, 30 that can be installed in the filter screen cavities 12A, 12B, 13A, and 13B, described hereinabove and illustrated in FIGS. 2, 5, and 14.

To control and/or actuate the filtration apparatus 10 a controller C, such as a programmable logic controller, a computer, an executable computer readable medium, or the like, can be used. For example, a programmable logic controller can be used to interface with a hydraulic power unit. For example, a controller C can interface with a rapid accelerator device assisted hydraulic power unit HPU such as an accumulator assisted hydraulic power unit HPU.

As shown in FIG. 1, a controller C, such as a programmable logic controller, computer, or the like, can be interfaced with a hydraulic power unit HPU that is assisted by a rapid accelerator device ACC to supply linear mechanical operation of the screen-bearing pistons. The locations of the screen-bearing piston 12 and 13 can be measured with linear transducers 14B and 15B shown in FIG. 1. Linear transducers 14B and 15B can send a ranged milliamp signal back to the controller C.

The accumulator assisted hydraulic power unit HPU can be capable of automatically charging via the controller C, which can increase each screen-bearing pistons velocity across the back flush discharge channels. This increased velocity can greatly reduce material loss during a screen change. In fact, in some embodiments, the amount of material loss due to movement past the back flush discharge channels can be minimal. The accumulator assisted hydraulic power unit HPU can also be capable of automatically discharging via the controller C, which decreases each screen-bearing pistons velocity inside of the housing 11 of filtration apparatus 10.

The controller C interfaced with the accumulator assisted hydraulic power unit HPU can also position each screen-bearing piston 12 and 13 within about 0.010 of an inch set point. Normal operating positions requiring accurate alignment of housing bores to screen-bearing piston bores can also be located to within about 0.010 of an inch set point. The capability of locating the screen-bearing pistons to within about 0.010 of an inch set point can aid in reduced polymer degradation areas. The controller C that is interfaced with the hydraulic power unit HPU can have a pre-programmed/controllable amount of time that the filtration apparatus is in the back flushing position, to increase efficiency. The controller C interfaced with the accumulator assisted hydraulic power unit HPU can also be preprogrammed with the safety interlock preventing both screen-bearing pistons to actuate at the same time and can prevent dead heading and possible injury. Further, the controller C interfaced with the accumulator assisted hydraulic power unit HPU can be preprogrammed to automatically initiate a back flushing sequence with a set pressure point, with a timed set point between back flush cycles, or with an on demand push button (not shown). The controller C can have a display (not shown) that can visually display the required operation of all screens at any point in time.

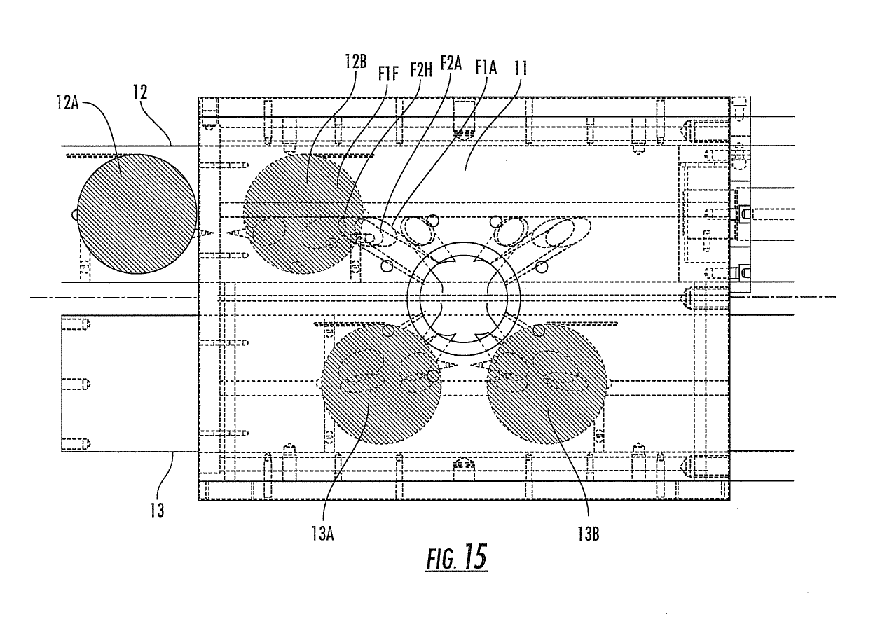

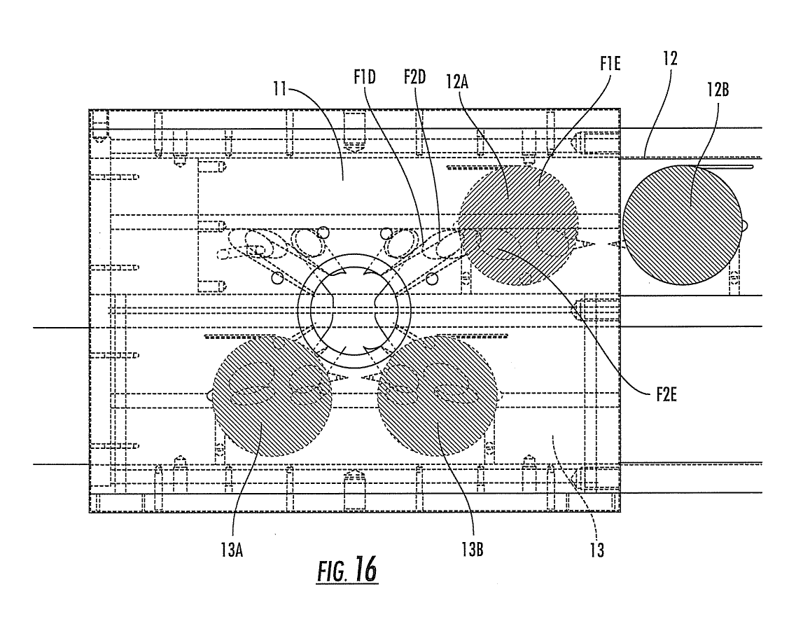

Each screen-bearing piston 12, 13 can have two or more screen changing positions to allow soiled filter screens or screen packs to be replaced. While in one or more screen changing positions, illustrated in FIGS. 15, 16, 17 and 18, at least three other filter screen cavities can allow material to continue being filtered. For example, the piston discharge channels F2E, F2F, F2G, F2H can be aligned with the discharge sub-channels F2A, F2B, F2C, F2D of the housing 11 and the piston supply channels F1E, F1F can be aligned with the supply sub-channels F1A, F1B, F1C, F1D of the housing 11 so that when one of filter screen cavity 12A, 12B, 13A, and 13B is in a screen changing position, the other filter screen cavities 12A, 12B, 13A, and 13B in the screen-bearing pistons 12, 13 continue to permit polymer flow. In this manner in the embodiment shown, when screen changing is occurring in one of the filter screen cavity 12A, 12B, 13A, and 13B, polymer can continue to flow through the other three of the four filter screen cavities 12A, 12B, 13A, and 13B.

As shown in FIG. 15, the screening-bearing piston 12 is in a screen changing position for changing the filter screen from the filter screen cavity 12A. In this position of the screening-bearing piston 12, the filter screen cavity 12B is positioned relative to the supply sub-channel F1A of the housing 11 and the discharge sub-channel F2A of the housing 11 to permit the flow of polymer therethrough while the filter screen in the filter screen cavity 12A is being changed. In particular, the large piston supply channel F1F of the filter screen cavity 12B intersects, or at least partially aligns, with the supply sub-channel F1A of the housing 11 to permit the flow of material, such as polymer, therethrough. At the same time, piston discharge channel F2H of the filter screen cavity 12B intersects, or at least partially aligns, with the discharge sub-channel F2A of the housing 11 to permit the flow of material, such as polymer therethrough. Since the filter screen cavities 13A, 13B and screening-bearing piston 13 are in their respective normal operational position, three of the four filter screen cavities 12B, 13A, and 13B continue to filter polymer. Such an arrangement, as with the back flushing positions, can reduce the number of incidences of frozen polymer within the filtration apparatus 10.

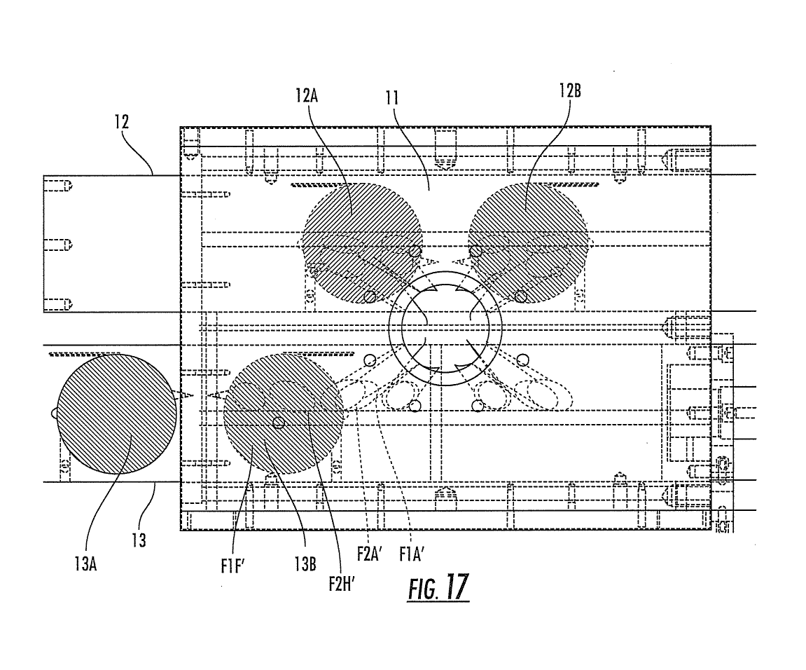

Similarly, the screening-bearing piston 12 as shown in FIG. 16 is in a screen changing position for changing the filter screen from the filter screen cavity 12B. In this position of the screening-bearing piston 12, the large piston supply channel F1E of the filter screen cavity 12A intersects, or at least partially aligns, with the supply sub-channel F1D of the housing 11 to permit the flow of material, such as polymer, therethrough. Also, piston discharge channel F2E of the filter screen cavity 12A intersects, or at least partially aligns, with the discharge sub-channel F2D of the housing 11 to permit the flow of material, such as polymer therethrough. Since the filter screen cavities 13A, 13B and screening-bearing piston 13 are in their respective normal operational position, three of the four filter screen cavities 12A, 13A, and 13B continue to filter polymer.

As shown in FIG. 17, the screening-bearing piston 13 is in a screen changing position for changing the filter screen from the filter screen cavity 13A. In this position of the screening-bearing piston 13, the filter screen cavity 13B is positioned relative to the supply sub-channel F1A′ of the housing 11 and the discharge sub-channel F2A′ of the housing 11 to permit the flow of polymer therethrough while the filter screen in the filter screen cavity 13A is being changed. In particular, the large piston supply channel F1F′ of the filter screen cavity 13B intersects, or at least partially aligns, with the supply sub-channel F1A′ of the housing 11 to permit the flow of material. At the same time, piston discharge channel F2H′ of the filter screen cavity 13B intersects, or at least partially aligns, with the discharge sub-channel F2A′ of the housing 11 to permit the flow of material, such as polymer therethrough. Since the filter screen cavities 12A, 12B and screening-bearing piston 12 are in their respective normal operational position, three of the four filter screen cavities 12A, 12B, and 13B continue to filter polymer.

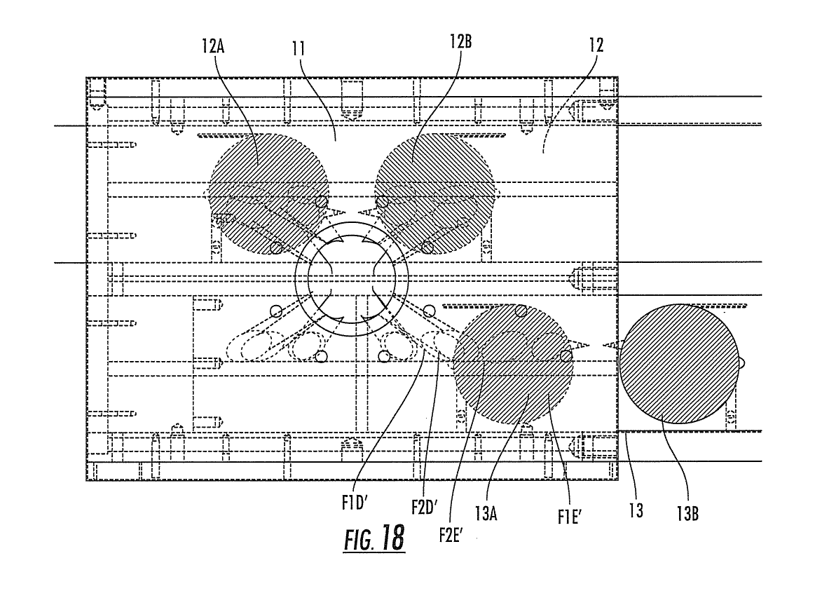

Similarly, the screening-bearing piston 13 as shown in FIG. 18 is in a screen changing position for changing the filter screen from the filter screen cavity 13B. In this position of the screening-bearing piston 13, the large piston supply channel F1E′ of the filter screen cavity 13A intersects, or at least partially aligns, with the supply sub-channel F1D′ of the housing 11 to permit the flow of material. Also, piston discharge channel F2E′ of the filter screen cavity 13A intersects, or at least partially aligns, with the discharge sub-channel F2D′ of the housing 11 to permit the flow of material. Since the filter screen cavities 12A, 12B and screening-bearing piston 12 are in their respective normal operational position, three of the four filter screen cavities 12A, 12B, and 13A continue to filter polymer.

Also, each screen-bearing piston 12, 13 can be actuated between two or more back flushing positions, allowing polymer flow from a downstream side of the housing 11 to be reversed and the contaminants removed from the respective screen pack to be discharged. The back flushing channel can be formed so that the back flushed polymer with the contaminants therein can be discharged from a side 11A of the housing 11. For example, side 11A can be a bottom side. Bottom side 11A can be about parallel to the general flow of the material that enters supply channel F1. FIG. 5 shows filter screen cavity 12A in the back flushing position. While filter screen cavity 12A is in the back flushing position, polymer flow can continue through filtration apparatus 10 at filter screen cavities 12B, 13A, and 13B, while the back flush discharge can exit the bottom side 11A of the housing 11. The formation of back flush channel through the one or more screen-bearing pistons 12, 13 and the housing 11 of filtration apparatus 10 are explained in more detail below.

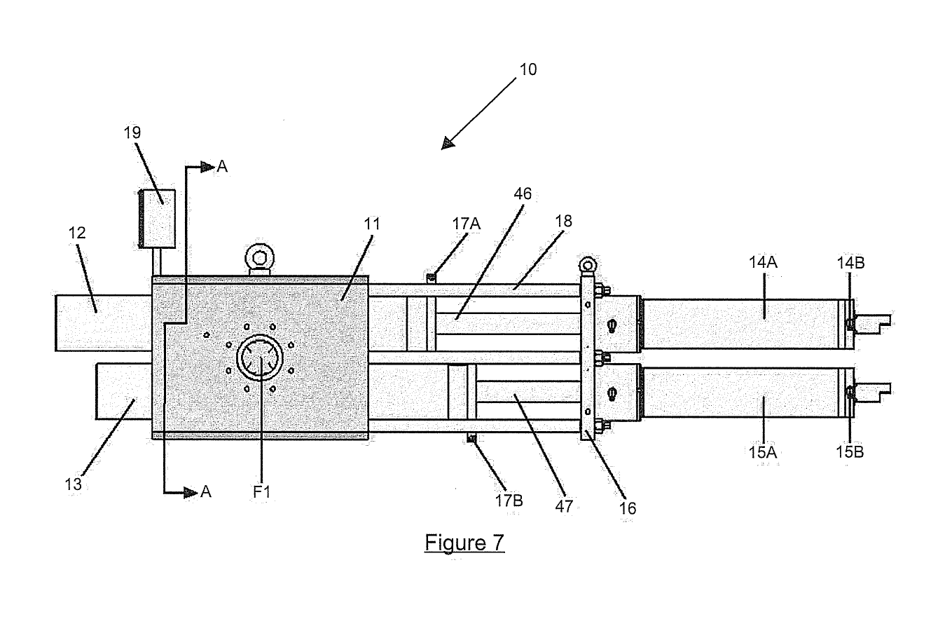

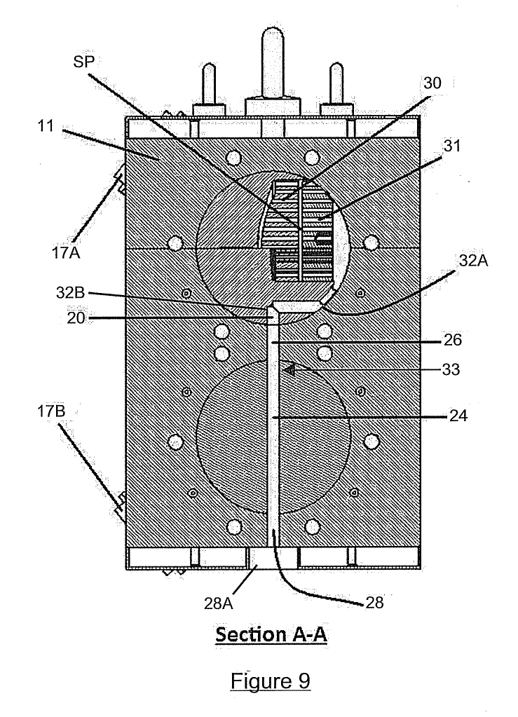

As shown in FIG. 7, the filtration apparatus 10 is back flushing filter screen cavity 12A illustrated in FIG. 2. Cross-section A-A, taken from FIGS. 5 and 7, is illustrated in further detail in FIGS. 8 and 9.

As shown in FIG. 8, screen-bearing piston 13 can be in its normal operating position. While screen-bearing piston 13 is in its normal operating position, screen-bearing piston-mating channel 24 can intersect with housing mating channel 26 and back flushing discharge channel 28. During the back flushing cycle of filter screen cavity 12A, polymer flow from flow bore F2A can travel through the breaker plate 30, across screen pack SP, and through filter screen retention plate 31, allowing contamination to be purged from the screen pack SP. As shown in FIG. 9, the purging material can flow through mating back flush channel 20, which includes an initial channel 32A and an intersecting channel 32B, in screen-bearing piston 12. As shown in FIGS. 8 and 9, the mating back flush channel 20 in the respective screen-bearing piston 12, 13 can comprise different sub-mating channels, for example, channels 32A and 32B. These channels 32A and 32B can be, for example, at different angles relative to each other.

The purging material can in turn travel through housing mating channel 26, further traveling through screen-bearing piston mating channel 24, finally exiting the filtration apparatus through back flushing discharge channel 28. As shown in FIG. 9, the purging material can direct contaminants through milled channels in the screen-bearing pistons to the middle of the apparatus during a back flush cycle. The centralized back flushing discharge channels 28 and 29, illustrated in FIG. 5, can prevent polymer freeze off in the back flush ports. The flushed material exiting beneath the housing can prevent injury, along with allowing material to be recollected beneath the housing. Each of the respective filter screen cavities 12A, 12B, 13A, and 13B, shown in FIGS. 2 and 5, can allow for the back flushing sequence, described hereinabove, to take place.

As shown in FIG. 8, when screen-bearing piston 12 is traveling to its screen change position, the polymer pressure inside of the filter screen cavity is capable of purging material as it passes over the housing mating channel 26, screen-bearing piston mating channel 24, and back flushing discharge channel 28. Each of the respective filter screen cavities can travel across similar channel geometry respectively, allowing for a pressure relief of the filter screen cavity before moving completely off line.

As shown in FIG. 6, back flush supply channels 12E and 12F can be incorporated in screen-bearing piston 12. Back flush supply channels 12E and 12F can allow for the filtration apparatus to control amounts of flush material being utilized. Back flush supply channels 12E and 12F can also facilitate the reduction and control of pressure variation downstream of the filtration apparatus. Further, back flush supply channels 12E and 12F can also be utilized during the venting process after a screen pack change, reducing polymer degradation in the back flush supply channels 12E and 12F. Identical back flush supply channels (not shown) are incorporated in screen-bearing piston 13, illustrated in FIG. 1.

As shown in FIGS. 8 and 9, the screen pack SP can be fixed in between the breaker plate 30 and filter screen retention plate 31. During normal operation, polymer can flow through the filter screen retention plate 31 then continues through screen pack SP, which is supported by the breaker plate 30. The convex design of the breaker plate 30 can aid in strength and dispersion of polymer.

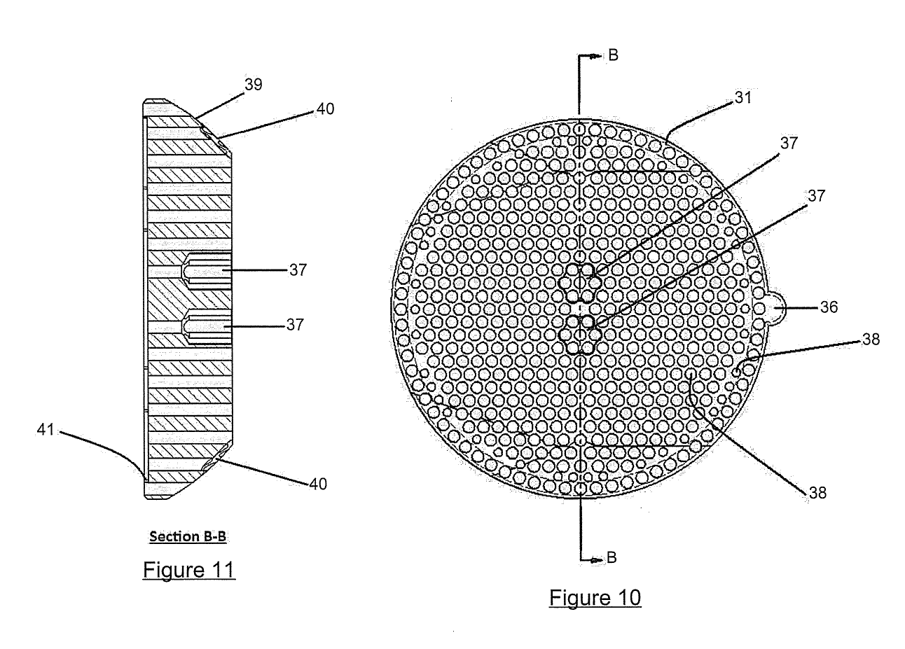

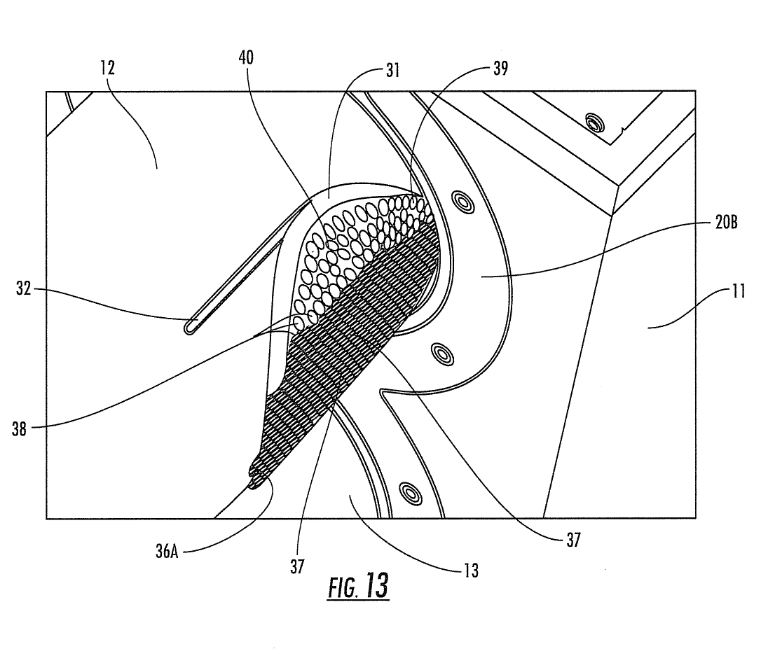

Referring to FIGS. 10, 11, 12, and 13, an example of a filter screen retention plate 31 for the filtration apparatus 10 is illustrated. As stated above, a plurality of removable filter screen retention plates can be used in the filtration apparatus 10 to hold the filter screens in place during a back flush cycle, or operation.

The filter screen retention plates 31 can comprises small flow channels. The filter screen retention plates 31 can create a pressure drop to disperse pressure throughout the entire filter screen cavity of the respective filter screen cavity 12A, 12B, 13A, and 13B. The filter screen retention plates 31 can be contoured to increase filter screen cavity volume consumption in the screen-bearing pistons 12, 13. The filter screen retention plates 31 can also accelerate the polymer to increase the rate of removal of screen contaminants. The filter screen retention plates 31 can also reduce the amount of material required for the removal of screen contaminants. The filter screen retention plates 31 can include large entrance chamfers to guide the filter screen retention plates 31 into the screen-bearing pistons 12, 13 and lock the filter screens in position. The filter screen retention plates 31 can include recessed surfaces configured to contact the filter screens to ease the removal of screen contaminants.

During the back flushing sequence, the reversal of polymer flow across the contaminated screen pack SP removes debris from the screen pack SP. More importantly, an evenly distributed polymer flow across the screen pack SP aids in thoroughly removing contamination from the screen pack. The screen pack SP can be fixed in between the breaker plate 30 and filter screen retention plate 31, as illustrated in FIGS. 8 and 9. As shown in FIG. 10, the drilled holes 38 in the filter screen retention plate 31 can be sized and placed to properly support the screen pack during the back flushing sequence. The drilled holes 38 in the filter screen retention plate 31 can also aid in increasing the filter screen cavity volume consumption. Increasing volume consumption can reduce residence time. It can also aid in minimizing amounts of back flush material required for a sufficient purge. As shown in FIG. 10, a locating pin 36 can be used to retain the filter screen retention plate 31 in proper alignment inside the screen-bearing piston.

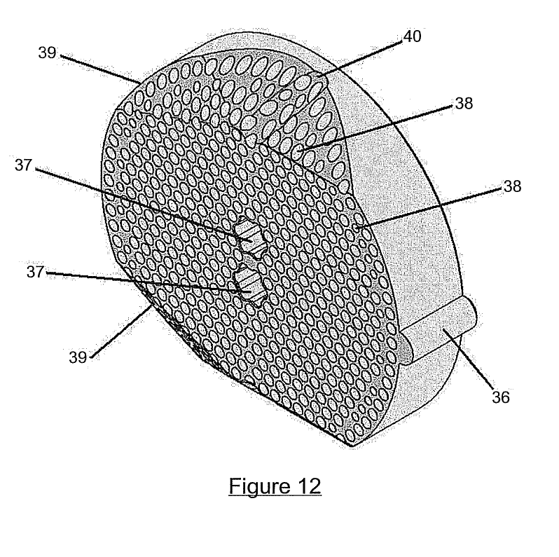

As shown in FIG. 2, each filter screen cavity 12A, 12B, 13A, and 13B can have a venting groove 42, 43, 44, and 45 extending therefrom in the screen-bearing pistons 12, 13 to release air from the polymer being process. FIG. 13 illustrates the filter screen retention plate location in the filtration apparatus 10. A milled venting channel 40 in the filter screen retention plate 31, which also intersects with a venting groove 42 in the screen-bearing piston 12, can be provided at each venting position, and can ensure that the unit can vent properly. Filter screen retention plate 31 can have a contoured shape, or chamfers, 39 as illustrated in FIG. 11 that can aid in retaining the filter screen retention plate 31 in the housing 11 of the filtration apparatus 10 during back flushing. The contoured shape, or chamfers, 29 in the filter screen retention plates 31 can help to guide the filter screen retention plates 31 into their respective screen-bearing piston cavities and lock the screen packs SP into position.

When a screen change is necessary, the filter screen retention plate 31 can be removed from screen-bearing piston 12, 13. The filter screen retention plate 31 can be removed with a device such as pliers can that has nose portions that can be inserted into drilled locations 37. During the back flushing sequence, polymer dispersion and contamination removal can be increased by using a relief channel, or recessed surface, 41 as illustrated in FIG. 11. During back flushing, the screen pack SP can deflect slightly into the recessed channel 41, aiding in pressure dispersion and debris removal. The amount of purged polymeric material can be reduced due to pressure drop created by hole size and placement as shown in FIG. 10.

Embodiments of the present disclosure shown in the Figures and described above are exemplary of numerous embodiments that can be made within the scope of the present subject matter. It is contemplated that the configurations of the filtration apparatuses and methods of use of the same can comprise numerous configurations other than those specifically disclosed. The scope of the present subject matter in this disclosure should be interpreted broadly.

What is claimed is:

1. A filtration apparatus for use in polymer processing systems, the filtration apparatus comprising:
a housing comprising a main supply channel and a main discharge channel, a portion of the main supply channel being divided into one or more supply sub-channels for directing a flow of polymer to two or more filter screens and a portion of the main discharge channel being divided into one or more discharge sub-channels for receiving a flow of polymer from the two or more filter screens;
one or more screen-bearing pistons, each screen-bearing piston comprising two or more filter screen cavities with each filter screen cavity configured to receive a filter screen and each screen-bearing piston comprising one or more piston supply channels that are alignable with the one or more supply sub-channels of the housing and one or more piston discharge channels that are alignable with the one or more discharge sub-channels of the housing; and
a back flush channel being formable for each filter screen cavity, each back flush channel comprising one or more mating channels in the housing and one or more mating channels in the one or more screen-bearing pistons when the screen-bearing piston for the respective back flush channel is in a back flushing position for the respective filter screen cavity.

2. The apparatus according to claim 1, wherein mating channels in the housing include a back flush discharge channel and the back flush discharge channels are positioned at the bottom of the housing.

3. The apparatus according to claim 2, wherein each back flush channel direct flow downward at a discharge outlet of the back flush discharge channel.

4. The apparatus according to claim 1, wherein each back flush channel directs a flow of material being purged at a discharge outlet of the respective back flush channel in a direction that is transverse to the direction of flow of material being filtered entering the main supply channel.

5. The apparatus according to claim 1, wherein each back flush channel directs flow of material being purged at a discharge outlet of the respective back flush channel in a direction that is about perpendicular to the direction of flow of material being filtered entering the main supply channel.

6. The apparatus according to claim 1, wherein each back flush channel comprising a discharge outlet that permits material purged from the filtration apparatus through the respective back flush channel to be recollected directly below the apparatus.

7. The apparatus according to claim 6, wherein the discharge outlet of each back flush channel permits material purged from the filtration apparatus through the respective back flush channel to be recollected without further contact with the apparatus after discharge from the discharge outlet.

8. The apparatus according to claim 6, wherein the back flush channels require minimal amounts of manual material removal from the apparatus.

9. The apparatus according to claim 1, wherein the back flush channels are formable in the middle of the housing for increased heat supplied to the back flush channels.

10. The apparatus according to claim 9, wherein the back flush discharge channel locations assist in the reduction of frozen polymer.

11. The apparatus according to claim 1, wherein each screen-bearing piston further comprises a back flush supply channel for each filter screen cavity, the back flush supply channels being configured to allow for adjustable amounts of the flow of material for back flushing supplied to the filter screen cavity.

12. The apparatus according to claim 11, wherein the back flush supply channels in the screen-bearing pistons allow for controllable amounts of downstream pressure variation during a back flushing cycle.

13. The apparatus according to claim 11, wherein the back flush supply channels in the screen-bearing pistons are utilized as ventilation channels to reduce polymer degradation areas in the apparatus.

14. The apparatus according to claim 1, wherein, when changing a filter screen from a respective filter screen cavity within one of the screen-bearing pistons, the back flush channel for the respective filter screen cavity provide pressure relief for the filter screen cavities before introducing the filter screen cavities to the atmosphere during any screen change operation.

15. The apparatus according to claim 1, wherein the mating channels in the housing that support the screen-bearing pistons direct contaminants through the mating channels in the screen-bearing pistons to the middle of the apparatus during a back flush cycle.

16. A filtration apparatus for use in polymer processing systems, the filtration apparatus comprising:
a housing comprising one or more main supply channels divided into multiple sub-channels directing a polymer flow through multiple filter screens, the housing including multiple discharge sub-channels combined into one or more main discharge channels, and the housing including multiple back flush discharge channels;
a plurality of screen-bearing pistons, each screen-bearing piston comprising multiple filter screen cavities, multiple adjustable back flush supply channels, and multiple adjustable back flush discharge channels;
a hydraulically operated power unit to supply linear movement of the plurality of screen-bearing pistons;
a controller for controlling operation of the hydraulic power unit and position control of the two screen-bearing pistons; and
a rapid accelerator device in communication with the hydraulically operated power unit and the controller to accelerate the linear movement of the plurality of screen-bearing pistons to reduce disruption of the flow of polymer being processed.

17. The apparatus according to claim 16, wherein the rapid accelerator device is configured to automatically charge before movement of one of the screen-bearing pistons by the hydraulically operated power unit to a screen changing position to permit a discharge of the rapid accelerator device during movement of the screen-bearing piston to and from a screen changing position to increase a velocity of the screen-bearing piston over the back flush discharge channels in the housing.

18. The apparatus according to claim 16, wherein the rapid accelerator device is configured to not discharge during movement of one of the screen-bearing pistons by the hydraulically operated power unit to at least one of a back flushing position, a normal operational position, or a venting position so that a velocity of the screen-bearing piston is not increased to more accurately hit the respective position to which the screen-bearing piston is being moved.

19. The apparatus according to claim 16, wherein the hydraulically operated power unit is configured to position the screen-bearing pistons within about 0.010 of an inch set point range.

20. The apparatus according to claim 19, wherein the hydraulically operated power unit is configured to align one or more piston discharge channels in the screen-bearing pistons with the discharge sub-channels in the housing within about 0.010 of an inch set point range to reduce polymer degradation areas.

21. The apparatus according to claim 16, wherein the controller is configured to operate the hydraulically operated power unit to control the amount of time for each back flush cycle to increase application efficiency.

22. The apparatus according to claim 16, wherein the hydraulically operated power unit is configured to interlock the screen-bearing pistons so that one screen-bearing piston will operate dependently of the other screen-bearing pistons while the other screen-bearing pistons remain in the normal operational position.

23. The apparatus according to claim 22, wherein the controller is configured to operate the hydraulically operated power unit to prevent the screen-bearing pistons from orienting themselves inappropriately to eliminate the possibility of disrupting the polymer flow.

24. The apparatus according to claim 16, wherein the controller is configured to operate the hydraulically operated power unit to achieve an automatic initiation of any screen change cycle for any filter screen by at least one of a timed set point between back flush cycles or based on a number of back flush cycles that the filter screen endures.

25. A filtration apparatus for use in polymer processing systems, the filtration apparatus comprising:
a housing having one or more main supply channels divided into multiple sub-channels directing polymer flow through multiple filter screens, the housing including multiple discharge sub-channels combined into one or more main discharge channels, and the housing including multiple back flush discharge channels;
a plurality of hydraulically operated screen-bearing pistons, each having multiple filter screen cavities, multiple adjustable back flush supply channels, and multiple adjustable back flush discharge channels; and
a plurality of removable filter screen retention plates to hold the screens in place during a back flush operation.

26. The apparatus according to claim 25, wherein the filter screen retention plates contain small flow channels.

27. The apparatus according to claim 26, wherein the filter screen retention plates create a pressure drop to disperse pressure throughout the entire filter screen cavity.

28. The apparatus according to claim 26, wherein the filter screen retention plates are contoured to increase filter screen cavity volume consumption in the screen-bearing pistons.

29. The apparatus according to claim 26, wherein the filter screen retention plates accelerate the polymer to increase the rate of removal of screen contaminants.

30. The apparatus according to claims 26, wherein the filter screen retention plates reduce the amount of polymer required for the removal of screen contaminants.

31. The apparatus according to claim 25, wherein the filter screen retention plates include large entrance chamfers to guide the filter screen retention plates into the screen-bearing pistons and lock the filter screens in position.

32. The apparatus according to claim 25, wherein the filter screen retention plates include recessed surfaces configured to contact the filter screens to ease the removal of screen contaminants.

33. A method of using a filtration apparatus for polymer processing, the method comprising:
providing a filtration apparatus comprising:
a housing comprising a main supply channel and a main discharge channel, a portion of the main supply channel being divided into one or more supply sub-channels for directing a flow of material to two or more filter screens and a portion of the main discharge channel being divided into one or more sub-channels for receiving a flow of material from the two or more filter screens;
one or more screen-bearing pistons, each screen-bearing piston comprising two filter screen cavities with each filter screen cavity configured to receive a filter screen and each screen-bearing piston comprising one or more piston supply channels that are alignable with the one or more supply sub-channels of the housing and one or more piston discharge channels that are alignable with the one or more supply sub-channels of the housing; and
a back flush channel being formable for each filter screen cavity, each back flush channel comprising one or more mating channels in the housing and one or more mating channels in the one or more screen-bearing pistons when the screen-bearing piston for the respective back flush channel is in a back flushing position for the respective filter screen cavity;
moving one of the screen-bearing pistons to a back flushing position for one of the filter screen cavities in the screen-bearing piston being moved;
aligning at least one of the mating channels of the housing with at least one of the mating channels of the moved screen-bearing piston to form the back flush channel for the filter screen cavity.

34. The method according to claim 33, further comprising back flushing a filter screen in the filter screen cavity and the screen-bearing piston that is in the back flush position.

35. The method according to claim 33, wherein, when the filter screen cavity is in a back flushing position, the other filter screen cavity in the screen-bearing piston continues to permit polymer flow.

36. The method according to claim 33, further comprising moving one of the screen-bearing pistons to a screen changing position for one of the filter screen cavities in the screen-bearing piston being moved.

37. The method according to claim 36, wherein, when the filter screen cavity is in a screen changing position, the other filter screen cavity in the screen-bearing piston continues to permit polymer flow.
